(19) United States
(12) Patent Application Publication
(10) Pub. No.: US 2006/0095797 A1
(43) Pub. Date: May 4, 2006

(54) Switching device for selective delivery of electrical power

(76) Inventor: Tsung-Yung Hung, Taipei (TW)

Correspondence Address: LIN & ASSOCIATES INTELLECTUAL PROPERTY, P.O. BOX 2339, SARATOGA, CA, 95070-0339, US

(21) Appl. No.: 10/978,054

(22) Filed: Oct. 30, 2004

(51) Int. Cl. G06F 1/26

(52) U.S. Cl. 713/300

(57) ABSTRACT

A switching device is provided for determining to which parts of a notebook computer an electrical power is delivered. The switching device is used in a notebook computer having an independently operating media module. The switching device is located at the output terminal of the notebook computer's power supply and, based on a control signal, determines the parts of the notebook computer to be powered. The independently operating media module, under an effect of the switching device, can directly play a video signal on the notebook computer's LCD display and speakers without powering on the notebook computer and booting up its operating system.

### BACKGROUND OF THE INVENTION

1. Field of the Invention

The present invention generally relates to switching devices and, more particularly, to the switching device installed in a notebook computer for selectively supplying power to the various parts of the notebook computer.

2. The Prior Arts

Recently notebook computers have become popular consumer electronics devices, especially for those users of which mobility is a necessity. Driven by the enormous market demand, more and more features are built into a notebook computer, making it not only a computational tool, but also a multimedia center. For example, some notebook computers now have a TV tuner built-in so that, with the appropriate operating system support, a user can directly watches video programs on a notebook's display.

To view the video programs, the notebook computer is powered on, the operating system is booted up, and a video viewing and playing application program is activated. Compared with TV sets and other home appliances, this process is rather time consuming, especially when the user simply wants to watch the video program without using other application programs. For notebook computers, usually equipped with a battery of limited supply of electrical power, booting up the entire system for simply watching video programs causes unnecessary waste of electrical power.

To overcome this and other problems, an independently operating media module is developed and built inside a notebook computer. This media module can directly drives the notebook computer's LCD display and speakers for viewing video programs without requiring the notebook computer to be powered on and the operating system to be booted up.

To further reduce the consumption of electrical power for notebook computers having an independently operating media module, a need has risen for directing the electrical power to the parts of the computer that really require it. For example, when the computer is operating, then the electrical power is directed to the computer only, not to the independently operating media module.

### SUMMARY OF THE INVENTION

Accordingly, the present invention is directed to provide a switching device that can control the supply of electrical power selectively between an independently operating media module inside a notebook computer and the notebook computer itself, so as to reduce the electrical power consumption.

Based on the foregoing objectives, the switching device provided by the present invention is located at the output terminal of the electrical power supply of a notebook computer having a built-in independently operating media module. Under the control of the switching device, which is driven by a control signal, the notebook computer's electrical power can be directed only to the media module, the LCD display, and the speakers so that a video signal can be directly played without powering on the notebook computer itself.

The foregoing and other objects, features, aspects and advantages of the present invention will become better understood from a careful reading of a detailed description provided herein below with appropriate reference to the accompanying drawings.

### BRIEF DESCRIPTION OF THE DRAWINGS

FIG. 1 is a schematic view of a notebook computer installed with the switching device according to the present invention.

FIG. 2 is a schematic view of a notebook computer installed with the switching device and operated with a remote control according to the present invention.

FIG. 3 is a schematic view of a notebook computer installed with the switching device and operated with a control panel according to the present invention.

FIG. 4 is a schematic view of a notebook computer installed with the switching device and operated with a selection switch according to the present invention.

### DETAILED DESCRIPTION OF THE PREFERRED EMBODIMENTS

In the following, detailed description along with the accompanied drawings is given to better explain preferred embodiments of the present invention. Please be noted that, in the accompanied drawings, some parts are not drawn to scale or are somewhat exaggerated, so that people skilled in the art can better understand the principles of the present invention.

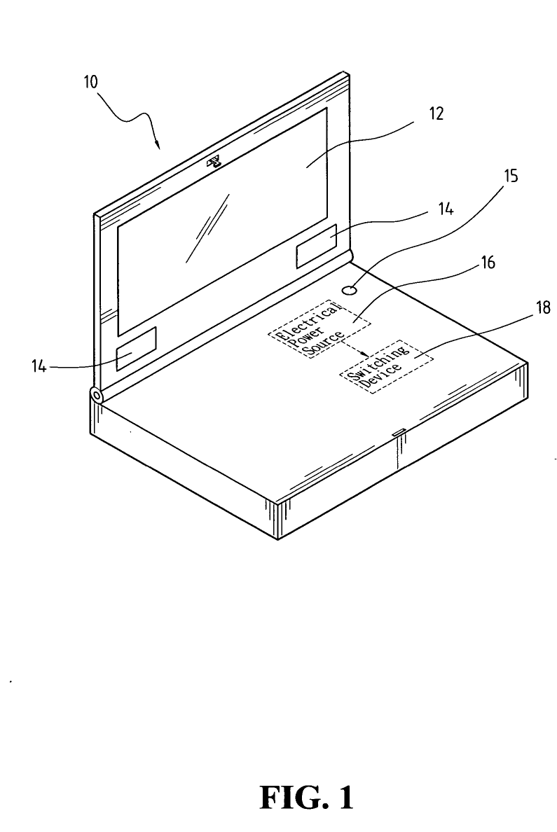

FIG. 1 is a schematic view of a notebook computer installed with the switching device according to the present invention. As shown in FIG. 1, the switching device 18 is installed in a notebook computer 10 having an independently operating media module (not shown). The switching device 18 is located at the output terminal of the electrical power source 16, so as to control the target to which the electrical power is directed based on a control signal.

In general, the power switch 15 of the notebook computer 10, when pressed, would cause the electrical power source 16 to power the various parts of the notebook computer 10 such as its BIOS, CPU, memory, chipsets, hard disk drives, etc. Within the present invention, however, the power switch 15 has additional features so as to achieve selective power delivery between the notebook computer 10 itself and the independently operating media module. These additional features of the power switch 15 are described as follows.

When playing a video signal, the media module takes the video signal from a video processing chip (not shown), which in turn takes its input from a video input interface (not shown), of the notebook computer 10, and plays the video signal on the LCD display 12 and the speakers 14. Only the foregoing parts of the notebook computer 10 are powered by the electrical power source 16.

The delivery of the electrical power can be controlled by the switching device 18 which, in turn, controlled by a control signal issued by the power switch 15, by the independently operating media module, or by a selection switch. Then, based on whether the switching device 18 has a memory for the original power delivery status, the switching device 18 can be further distinguished between a holding mode and a switching mode. In the following, the delivery of the electrical power controlled by the power switch 15, along with the holding and switching modes, is described first.

As shown in FIG. 1, when the power switch 15 is pressed, only the notebook computer 10 is powered while the independently operating media module is not receiving any power. In this way, electrical power is conserved as no power is wasted on the in-operative media module.

When the notebook computer 10 is shut down by its user into an in-operative state, the switching device 18 would be either in a holding mode or a switching mode. If the switching device 18 is in the holding mode, the independently operating media module remains powerless. If the switching device 18 is in the switching mode, the electrical power is then directed to the independently operating media module. However, when a user requests to turn on the independently operating module, the electrical power is directed to the media module regardless of the mode the switching device 18 is operating in. In the following, the delivery of the electrical power controlled by the independently operating media module is described.

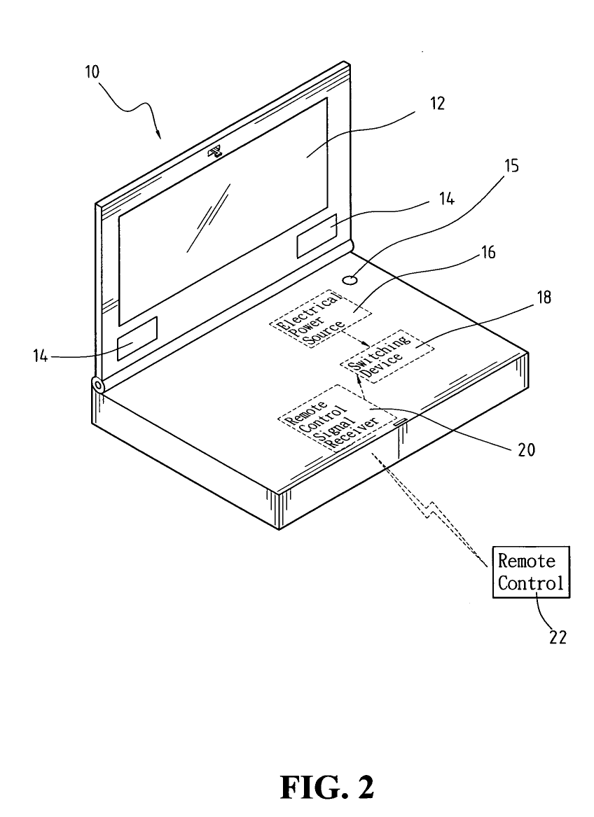

FIG. 2 is a schematic view of a notebook computer installed with the switching device and operated with a remote control according to the present invention. As shown in FIG. 2, the notebook computer has a built-in remote control signal receiver 20, through which a power button on the remote control 22 can issue a request to turn on the independently operating media module. The remote control 22 further contains other operation buttons such as play/pause, forward, backward, stop, fast forward, fast backward buttons.

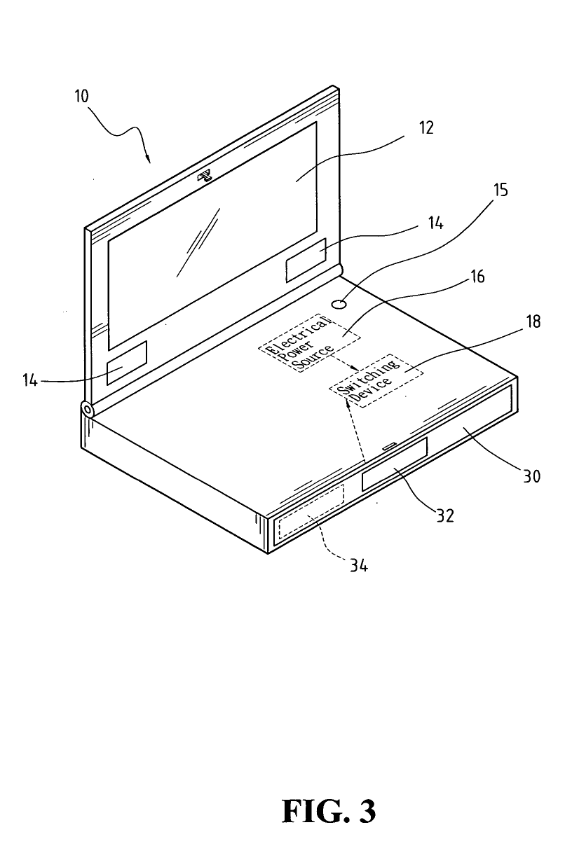

FIG. 3 is a schematic view of a notebook computer installed with the switching device and operated with a control panel according to the present invention. As shown in FIG. 3, the casing of the notebook computer 10 has a control panel 30 with a number of operation buttons 32 (similar to those on the remote control 22) for controlling the video playing. The control panel 30 may further contain a display 34 for showing operation status. Similarly, a user can use the power button (one of the operation buttons 32) to issue a request to turn on the independently operating media module.

Both the power buttons on the control panel 30 and the remote control 22, when pressed, would issue a request to the independently operating media module which, in turn, would send a control signal to the switching device 18. The control signal is different from that sent by the power switch 15. The control signal sent by the independently operating media module instructs the switching device 18 to supply electrical power to the individually operating media module only, and not to the notebook computer 10.

If the independently operating media module is turned off by a user into an in-operative state, whether the notebook computer 10 would receive electrical power from the electrical power source 16 depends on the mode the switching device 18 is operating in. If the switching device 18 is in the holding mode, the electrical power is not directed to the notebook computer 10 and the notebook computer 10 remains powerless. If the switching device 18 is in the switching mode, the electrical power is then directed to the notebook computer 10. However, when a user requests to turn on the notebook computer 10 by pressing the power switch 15, the electrical power is directed to the notebook computer 10 regardless of the mode the switching device 18 is operating in.

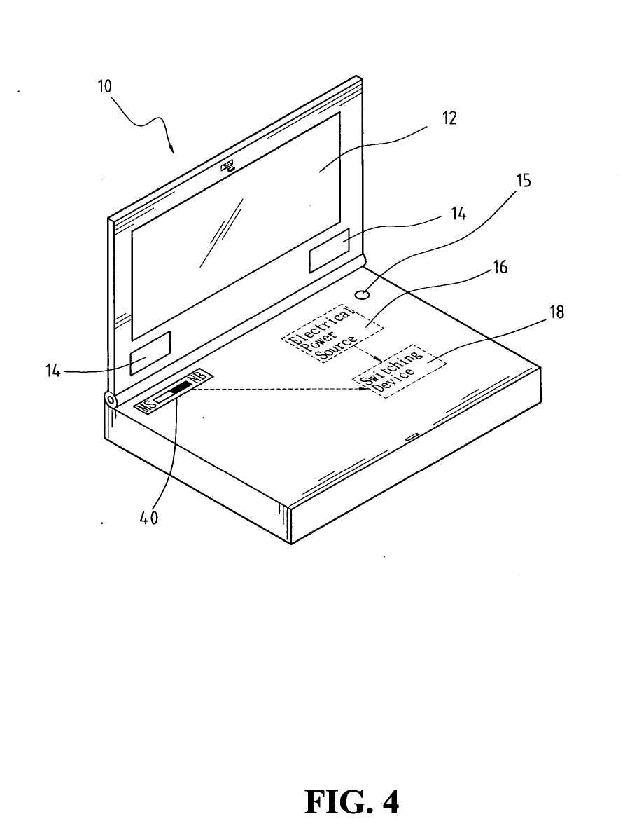

FIG. 4 is a schematic view of a notebook computer installed with the switching device and operated with a selection switch according to the present invention. As shown in FIG. 4, a selection switch 40 is installed on the notebook computer 10's casing. With the selection switch 40, a user could directly determine to which the electrical power is delivered. If the selection switch 40 is set to NB (that is, the notebook computer 10), only the notebook computer 10 is supplied with the electrical power. If the selection switch 10 is set to MS (that is, the independently operating media module), only the independently operating media module is supplied with the electrical power.

Although the present invention has been described with reference to the preferred embodiments, it will be understood that the invention is not limited to the details described thereof. Various substitutions and modifications have been suggested in the foregoing description, and others will occur to those of ordinary skill in the art. Therefore, all such substitutions and modifications are intended to be embraced within the scope of the invention as defined in the appended claims.

What is claimed is:

1. A switching device for selective delivery of electrical power, used in a notebook computer having an independently operating media module which directly plays a video signal on said notebook computer's display and speakers without powering on said notebook computer and without booting up an operating system, characterized in that said switching device determinines, based on a control signal, to which parts of said notebook computer an electrical power from an electrical power source of said notebook computer is delivered.

2. The switching device as claimed in claim 1, wherein said control signal is issued when a power switch of said notebook computer is pressed, causing said electrical power supplied to said notebook computer, not to said independently operating media module.

3. The switching device as claimed to claim 2, wherein, after said power switch of said notebook computer is pressed, and later after said notebook computer is shut down and becomes in-operative, said electrical power remains not supplied to said independently operating media module.

4. The switching device as claimed in claim 2, wherein, after said power switch of said notebook computer is pressed, and later after said notebook computer is shut down and becomes in-operative, said electrical power is supplied to said independently operating media module.

5. The switching device as claimed in claim 1, wherein said control signal is issued when said independently operating media module receives a turn-on request, causing said electrical power supplied to said independently operating media module, not to said notebook computer.

6. The switching device as claimed in claim 5, wherein said turn-on request is sent by pressing a power button within a control panel on said notebook computer's casing.

7. The switching device as claimed in claim 6, wherein said control panel further comprises a display for showing an operation status.

8. The switching device as claimed in claim 5, wherein said turn-on request is sent by a remote control signal receiver, which is triggered by a remote control signal sent by a remote control when a power button on said remote control is pressed.

9. The switching device as claimed in claim 6, wherein said control panel further comprises an operation button for controlling and playing said video signal.

10. The switching device as claimed in claim 5, wherein, after said independently operating media module receives said turn-on request, and later after said independently operating media module is shut down and becomes in-operative, said electrical power remains not supplied to said notebook computer.

11. The switching device as claimed in claim 5, wherein, after said independently operating media module receives said turn-on request, and later after said independently operating media module is shut down and becomes in-operative, said electrical power is supplied to said notebook computer.

12. The switching device as claimed in claim 1, wherein said control signal is issued by a selection switch located on said notebook computer's casing.

13. The switching device as claimed in claim 12, wherein, when said selection switch is set to one state, said electrical power is supplied only to said notebook computer and, when said selection is set the other state, said electrical power is supplied only to said independently operating media module.

14. The switching device as claimed in claim 6, wherein said remote control further comprises an operation button for controlling and playing said video signal.
